(19) United States
(12) Patent Application Publication
(10) Pub. No.: US 2025/0372594 A1
(43) Pub. Date: Dec. 4, 2025

(54) METHOD FOR PRODUCING BIPOLAR ELECTRODE

(71) Applicant: TOYOTA JIDOSHA KABUSHIKI KAISHA, Toyota-shi Aichi-ken (JP)

(72) Inventors: Minehiro FUNATO, Toyota-shi Aichi-ken (JP); Nariaki MIKI, Okazaki-shi Aichi-ken (JP)

(73) Assignee: TOYOTA JIDOSHA KABUSHIKI KAISHA, Toyota-shi Aichi-ken (JP)

(21) Appl. No.: 19/215,623

(22) Filed: May 22, 2025

(30) Foreign Application Priority Data
May 28, 2024 (JP) 2024-086594

(51) Int. Cl. H01M 4/04; H01M 4/02

(52) U.S. Cl. CPC H01M 4/0414; H01M 4/0404; H01M 4/043; H01M 2004/021; H01M 2004/029

(57) ABSTRACT

A method for producing a bipolar electrode includes obtaining a bipolar electrode respectively having a positive electrode mixture layer and a negative electrode mixture layer at both surfaces of an electrode foil through: a positive electrode mixture coating step of coating a positive electrode mixture coating liquid on one surface of an electrode foil and drying the positive electrode mixture coating liquid, to form a positive electrode mixture coating film; a first pressing step of pressing the electrode foil having the positive electrode mixture coating film; a negative electrode mixture coating step of coating a negative electrode mixture coating liquid on another surface of the electrode foil by a screen printing method and drying the negative electrode mixture coating liquid, to form a negative electrode mixture coating film; and a second pressing step of pressing the electrode foil having the negative electrode mixture coating film.

### CROSS-REFERENCE TO RELATED APPLICATION

This application is based on and claims priority under 35 USC 119 from Japanese Patent Application No. 2024-086594, filed on May 28, 2024, the disclosure of which is incorporated by reference herein.

### BACKGROUND

### Technical Field

The present disclosure relates to a method for producing a bipolar electrode.

### Background Art

Conventionally, various coating methods have been used as a method of coating a paste when producing a battery.

For example, Japanese Patent Application Laid-Open (JP-A) No. 2003-276353 discloses a method for producing a thin battery. In this method, a metal mask is composed of a printed pattern portion at which a paste filling window is formed and a thin mask holding portion that surrounds the printed pattern portion; a positioning pin is pushed into a fixing pin insertion hole that is formed at the mask holding portion, to fix the metal mask to a frame member for battery production; further, a tensile force for maintaining an expanded state of the printed pattern portion is imparted by the mask holding portion; a sheet member in which a first active material has been filled into an active material filling chamber is fixed to the frame member in a manner such that the sheet member is sandwiched between an electrode plate and a separator; the metal mask and the frame member are fastened to each other so that the paste filling window is positioned above a surface of the separator; and a second electrode active material is filled into the paste filling window with a squeegee.

### SUMMARY

Conventionally, when producing a bipolar electrode respectively having a positive electrode mixture layer and a negative electrode mixture layer at both surfaces of an electrode foil, it has been produced by coating a positive electrode mixture coating liquid on one surface of the electrode foil, coating a negative electrode mixture coating liquid on the other surface of the electrode foil, and thereafter, collectively applying pressing thereto. However, when collective pressing is performed after the positive electrode mixture coating liquid and the negative electrode mixture coating liquid have been coated, it is difficult to respectively adjust the positive electrode mixture layer and the negative electrode mixture layer to arbitrary densities. For this reason, there has been a demand for a production method in which a positive electrode mixture layer and a negative electrode mixture layer can be respectively adjusted to arbitrary densities, and each of the positive electrode mixture layer and the negative electrode mixture layer can be favorably formed.

The present disclosure has been made in view of the above circumstances. The present disclosure provides a method for producing a bipolar electrode in which a positive electrode mixture layer and a negative electrode mixture layer can respectively be favorably formed on both surfaces of an electrode foil, and in which the positive electrode mixture layer and the negative electrode mixture layer can be respectively adjusted to arbitrary densities.

Aspects according to the present disclosure include the following aspects.

A first aspect of the present disclosure provides a method for producing a bipolar electrode, the method including obtaining a bipolar electrode respectively having a positive electrode mixture layer and a negative electrode mixture layer at both surfaces of an electrode foil through the following steps:
a positive electrode mixture coating step of coating a positive electrode mixture coating liquid on one surface of an electrode foil and drying the positive electrode mixture coating liquid, to form a positive electrode mixture coating film;
a first pressing step of pressing the electrode foil having the positive electrode mixture coating film;
a negative electrode mixture coating step of coating a negative electrode mixture coating liquid on the other surface of the electrode foil by a screen printing method and drying the negative electrode mixture coating liquid, to form a negative electrode mixture coating film; and
a second pressing step of pressing the electrode foil having the negative electrode mixture coating film.

A second aspect of the present disclosure provides the method for producing a bipolar electrode according to the first aspect, wherein the viscosity of the negative electrode mixture coating liquid at a shear rate of 1 s⁻¹ is from 10,000 mPa·s to 30,000 mPa·s.

A third aspect of the present disclosure provides the method for producing a bipolar electrode according to the first or second aspect, wherein the printing pressure in the screen printing method in the negative electrode mixture coating step is from 0.15 MPa to 0.4 MPa.

A fourth aspect of the present disclosure provides the method for producing a bipolar electrode according to any one of the first to third aspects, wherein the squeegee speed in the screen printing method in the negative electrode mixture coating step is 200 mm/s or less.

A fifth aspect of the present disclosure provides the method for producing a bipolar electrode according to any one of the first to fourth aspects, wherein, in the negative electrode mixture coating step, coating of the negative electrode mixture coating liquid on the other surface by the screen printing method is performed while suctioning the surface of the electrode foil on a side having the positive electrode mixture coating film to a suction table, and while fixing an uncoated portion of the other surface, at which the negative electrode mixture coating liquid is not to be coated, by a jig.

According to the present disclosure, a method for producing a bipolar electrode is provided, in which a positive electrode mixture layer and a negative electrode mixture layer can respectively be favorably formed on both surfaces of an electrode foil, and in which the positive electrode mixture layer and the negative electrode mixture layer can be respectively adjusted to arbitrary densities.

### BRIEF DESCRIPTION OF DRAWINGS

FIG. 1 is a schematic perspective view illustrating an example of a method for coating a negative electrode mixture coating liquid on an electrode foil by a screen printing method.

FIG. 2A is a schematic top view illustrating an electrode foil in a state in which a surface on a side having a positive electrode mixture coating film is suctioned to a suction table, and in which an uncoated portion of the other surface, at which the negative electrode mixture coating liquid is not to be coated, has been fixed by a jig.

FIG. 2B is schematic cross-sectional view of FIG. 2A.

### DETAILED DESCRIPTION OF THE EMBODIMENTS

An embodiment, which is an example of the present disclosure, will be explained below. These explanations are provided to describe an example of embodiments, and do not limit the scope of the present disclosure.

In numerical ranges described in a stepwise manner in the present specification, an upper limit value or lower limit value that is described in one numerical range may be replaced by an upper limit value or lower limit value of another numerical range described in a stepwise manner.

Respective components may contain plural substances corresponding thereto.

When amounts of respective components in a composition are referred to, in cases in which plural types of substances corresponding to the respective components are present in the composition, unless particularly specified otherwise, this means a total amount of the corresponding plural types of substances that are present in the composition.

The term “step” includes not only independent steps, and as long as the intended action of the step is achieved, such a step is encompassed by this term even if it cannot be clearly distinguished from other steps.

### Method for Producing Bipolar Electrode

In a method for producing a bipolar electrode according to an embodiment of the present disclosure, a bipolar electrode respectively having a positive electrode mixture layer and a negative electrode mixture layer at both surfaces of an electrode foil is obtained through the following steps.
(1) A positive electrode mixture coating step of coating a positive electrode mixture coating liquid on one surface of an electrode foil and drying the positive electrode mixture coating liquid, to form a positive electrode mixture coating film
(2) A first pressing step of pressing the electrode foil having the positive electrode mixture coating film
(3) A negative electrode mixture coating step of coating a negative electrode mixture coating liquid on the other surface of the electrode foil by a screen printing method and drying the negative electrode mixture coating liquid, to form a negative electrode mixture coating film
(4) A second pressing step of pressing the electrode foil having the negative electrode mixture coating film

According to the method for producing a bipolar electrode according to an embodiment of the present disclosure, the positive electrode mixture layer and the negative electrode mixture layer can respectively be favorably formed on both surfaces of the electrode foil, and the positive electrode mixture layer and the negative electrode mixture layer can be respectively adjusted to arbitrary densities.

Conventionally, when producing a bipolar electrode respectively having a positive electrode mixture layer and a negative electrode mixture layer at both surfaces of an electrode foil, it has been produced by coating a positive electrode mixture coating liquid on one surface of an electrode foil to form a positive electrode mixture coating film, coating a negative electrode mixture coating liquid on the other surface of the electrode foil to form a negative electrode mixture coating film, and pressing the electrode foil having the positive electrode mixture coating film and the negative electrode mixture coating film. That is to say, a bipolar electrode has been produced by collectively pressing both coating films after forming the positive electrode mixture coating film and the negative electrode mixture coating film. However, when pressing is collectively performed on the positive electrode mixture coating film and the negative electrode mixture coating film, it is difficult to respectively adjust the positive electrode mixture layer and the negative electrode mixture layer to arbitrary densities.

Therefore, in the method for producing a bipolar electrode according to an embodiment of the present disclosure, the first pressing step is provided after forming the positive electrode mixture coating film on the one surface of the electrode foil, and then, the second pressing step is provided after forming the negative electrode mixture coating film on the other surface of the electrode foil. Consequently, the density of the positive electrode mixture layer and the density of the negative electrode mixture layer can be adjusted separately.

However, in the first pressing step of forming the positive electrode mixture layer, since the positive electrode mixture layer is formed only on the one surface of the electrode foil, warping occurs after the pressing. Furthermore, when the positive electrode mixture layer is formed on the one surface of the electrode foil by the first pressing step, so-called denting may occur in which a dent in the shape of the positive electrode mixture layer remains on the electrode foil. As a result, concavities and convexities occur at the electrode foil due to the effects of the aforementioned warping and denting, and it becomes difficult to coat the negative electrode mixture coating liquid on the other surface of the electrode foil to form the negative electrode mixture coating film.

Therefore, in the method for producing a bipolar electrode according to an embodiment of the present disclosure, a screen printing method is applied in order to coat the negative electrode mixture coating liquid to form the negative electrode mixture coating film. Consequently, since the ability to follow concavities and convexities is improved, the negative electrode mixture coating liquid can be favorably coated on the other surface of the electrode foil, and the negative electrode mixture coating film can be favorably formed.

As a result, according to an embodiment of the present disclosure, the positive electrode mixture layer and the negative electrode mixture layer can respectively be favorably formed on both surfaces of the electrode foil, and the positive electrode mixture layer and the negative electrode mixture layer can be respectively adjusted to arbitrary densities.

In the positive electrode mixture layer of the bipolar electrode, an energy density can be improved, for example, by further increasing the density, while in the negative electrode mixture layer, an ion diffusivity can be improved, for example, by further decreasing the density. According to an embodiment of the present disclosure, the densities of the positive electrode mixture layer and the negative electrode mixture layer can respectively be arbitrarily adjusted, also for addressing such demands,.

Each step of the method for producing a bipolar electrode according to an embodiment of the present disclosure will be explained below.

### (1) Positive Electrode Mixture Coating Step

In the positive electrode mixture coating step, the positive electrode mixture coating liquid is coated on the one surface of the electrode foil and dried to form the positive electrode mixture coating film.

### Electrode Foil

As the electrode foil, a conventionally known bipolar-type electrode foil is used. Specific examples thereof include a laminate foil in which a positive electrode foil and a negative electrode foil are laminated. For the positive electrode foil in the laminate foil, a metal having good conductivity is used, and, for example, an aluminum foil is preferable. For the negative electrode foil, a metal having good conductivity is used, and, for example, a copper foil is preferable.

### Positive Electrode Mixture Coating Liquid

The positive electrode mixture coating liquid contains, for example, a positive electrode active material, a binder, other components, a solvent, and the like.

Examples of the positive electrode active material include lithium nickel cobalt manganese composite oxides (hereinafter, sometimes simply referred to as “LNCMs”). The simplest LNCMs are represented by the following general formula: LiNiₓCo_{y}Mn_{z}O₂ (in the formula, x, y, and z satisfy 0<x<1, 0<y<1, 0<z<1, and x+y+z=1). In addition to Li, Ni, Co, and Mn, the LNCMs may contain other additional elements, for example, transition metal elements other than Ni, Co, and Mn, typical metal elements other than Li, and the like. Furthermore, examples of other positive electrode active materials include lithium nickel composite oxides, lithium cobalt composite oxides, and lithium nickel manganese composite oxides.

Examples of the binder contained in the positive electrode mixture coating liquid include vinyl halide resins such as polyvinylidene fluoride (PVdF).

The positive electrode mixture coating liquid may further contain other components such as a conductive material. Examples of the conductive material include non-graphitizable carbon, graphitizable carbon such as carbon black, and graphite.

Examples of the solvent contained in the positive electrode mixture coating liquid include water.

### Coating and Drying

In the positive electrode mixture coating step, the one surface of the electrode foil (for example, a surface at an aluminum foil side when a laminate foil of an aluminum foil and a copper foil is used) is coated with the positive electrode mixture coating liquid, and the positive electrode mixture coating liquid is dried. The coating method is not particularly limited, and conventionally known coating methods can be employed. Furthermore, the drying method is also not particularly limited, and conventionally known drying methods, for example a drying method using a drying furnace, can be employed.

It should be noted that the positive electrode mixture coating liquid is coated on the electrode foil such that, usually, an uncoated portion at which the positive electrode mixture coating liquid is not coated is formed at a periphery of the positive electrode mixture coating film.

### (2) First Pressing Step

In the first pressing step, the electrode foil having the positive electrode mixture coating film is pressed. The pressing method is not particularly limited, and a conventionally known pressing method can be employed. For example, examples of the pressing method include a method of pressing by passing the electrode foil having the positive electrode mixture coating film, between two opposing rolls.

### (3) Negative Electrode Mixture Coating Step

In the negative electrode mixture coating step, the negative electrode mixture coating liquid is coated on the other surface of the electrode foil (for example, a surface on a copper foil side when a laminate foil of an aluminum foil and a copper foil is used) by a screen printing method, and the negative electrode mixture coating liquid is dried, to form the negative electrode mixture coating film.

### Coating by Screen Printing

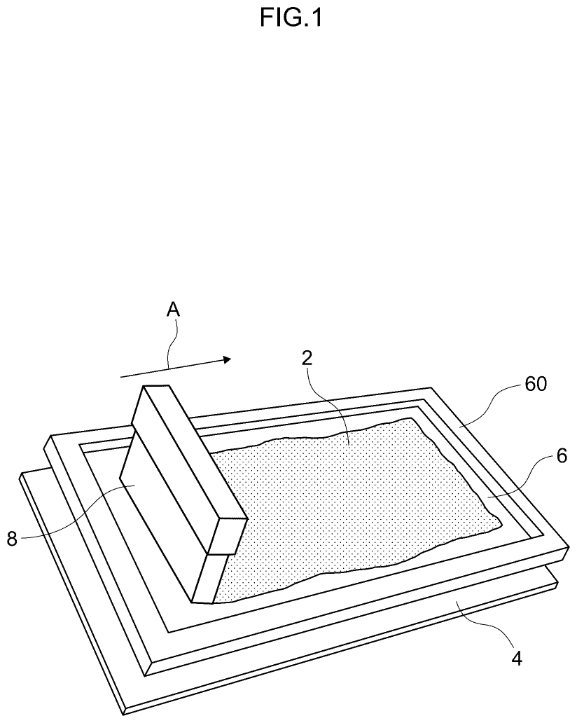

The method of coating the negative electrode mixture coating liquid on the other surface of the electrode foil by a screen printing method will be explained with reference to FIG. 1. FIG. 1 is a schematic perspective view illustrating an example of the method of coating the negative electrode mixture coating liquid on the electrode foil by a screen printing method.

As shown in FIG. 1, the other surface side of an electrode foil 4 is placed so as to be up (up in a gravity direction), and a screen 6 that has been stretched within a frame 60 is arranged above the electrode foil 4. A negative electrode mixture coating liquid 2 is arranged on the screen 6, and a squeegee 8 is moved in an arrow A direction while pressing the negative electrode mixture coating liquid 2 toward a screen 6 side with the squeegee 8. In the screen 6, only a region in which the negative electrode mixture coating liquid 2 is to be coated on the electrode foil 4 has a mesh shape, and the negative electrode mixture coating liquid 2 is coated in a desired region on the electrode foil 4 by passing the negative electrode mixture coating liquid 2 through holes of the mesh.

By applying a screen printing method, the ability to follow concavities and convexities can be improved, and the negative electrode mixture coating liquid can be favorably coated on the other surface of the electrode foil. As a screen printing machine to be used, for example, a commercially available screen printing machine may be used, and a flat bed printing machine is preferred.

The viscosity of the negative electrode mixture coating liquid at a shear rate of 1 s⁻¹ is preferably from 10,000 mPa·s to 30,000 mPa·s. When the viscosity is 10,000 mPa·s or more, dripping of the negative electrode mixture coating liquid from the screen (so-called “dripping from the mesh”) is reduced. When the viscosity is 30,000 mPa·s or less, remaining of the negative electrode mixture coating liquid, which should be coated on the electrode foil, on the screen (so-called “haze on the mesh”) is reduced. The viscosity of the negative electrode mixture coating liquid is measured using a viscometer under the condition of a shear rate of 1 s⁻¹.

A printing pressure in the screen printing method (that is to say, a pressure exerted by the squeegee) is preferably from 0.15 MPa to 0.4 MPa. When the printing pressure is 0.15 MPa or more, variation in the amount of the negative electrode mixture coating liquid that is coated on the electrode foil through the mesh of the screen is reduced. When the printing pressure is 0.4 MPa or less, damage to the screen is reduced.

The moving speed of the squeegee in the screen printing method is preferably 200 mm/s or less. When the moving speed of the squeegee is 200 mm/s or less, variation in the amount of the negative electrode mixture coating liquid that is coated on the electrode foil through the mesh of the screen is reduced. It should be noted that, with respect to the lower limit of the moving speed, there is no limitation as far as the moving speed is greater than 0 mm/s.

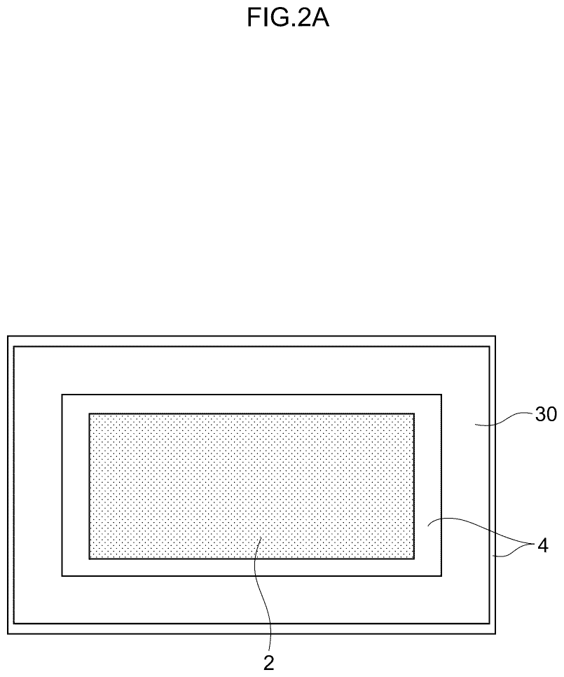

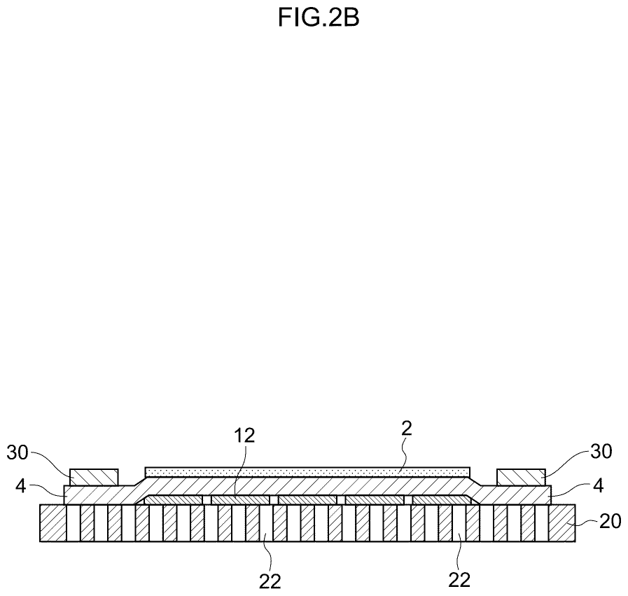

Here, experimental examples regarding the viscosity of the negative electrode mixture coating liquid, the printing pressure in the screen printing method, and the moving speed of the squeegee will be described, and the effects thereof will be explained. It should be noted that in the tests described below, as shown in FIGS. 2A and 2B, the negative electrode mixture coating liquid was coated on the other surface by the screen printing method while the surface of the electrode foil on the side having the positive electrode mixture coating film was suctioned to a suction table, and while an uncoated portion of the other surface, at which the negative electrode mixture coating liquid was not coated, was fixed by a jig (details of FIGS. 2A and 2B will be described later).

The negative electrode mixture coating liquid was coated on the electrode foil by the screen printing method while changing the viscosity of the negative electrode mixture coating liquid. As a result, while coating was favorably carried out in an example in which the viscosity was 10,000 mPa·s and an example in which the viscosity was 30,000 mPa·s, when the viscosity was 5,000 mPa·s, dripping from the mesh (mesh leakage) occurred, and when the viscosity was 50,000 mPa·s, haze on the mesh occurred.

TABLE 1

| Viscosity [mPa · s] | |
|---|---|
| (shear rate of 1 s⁻¹) | Coating State |
| 5,000 | Mesh Leakage occurred |
| 10,000 | Favorable |
| 30,000 | Favorable |
| 50,000 | Coating Failure and Haze on the Mesh |

The negative electrode mixture coating liquid was coated on the electrode foil by the screen printing method while changing the printing pressure. As a result, while coating was favorably carried out in an example in which the printing pressure was 0.15 MPa and an example in which the printing pressure was 0.35 MPa, when the printing pressure was 0.06 MPa, variation in the amount of the negative electrode mixture coating liquid that was coated on the electrode foil occurred.

TABLE 2

| Printing Pressure [MPa] | Variation [%] |
|---|---|
| 0.06 | 22.5 |
| 0.15 | 7 |
| 0.35 | 5.5 |

The negative electrode mixture coating liquid was coated on the electrode foil by the screen printing method while changing the squeegee speed. As a result, while coating was favorably carried out in an example in which the speed was 50 mm/s and an example in which the speed was 200 mm/s, when the speed was 500 mm/s, variation in the amount of the negative electrode mixture coating liquid that was coated on the electrode foil occurred.

TABLE 3

| Squeegee Speed [mm/s] | Variation [%] |
|---|---|
| 50 | 10.5 |
| 200 | 7 |
| 500 | 23.5 |

In the negative electrode mixture coating step, it is preferable to carry out the coating of the negative electrode mixture coating liquid on the other surface by the screen printing method while suctioning the surface of the electrode foil on the side having the positive electrode mixture coating film to the suction table, and while fixing the uncoated portion of the other surface, at which the negative electrode mixture coating liquid is not to be coated, by a jig. By carrying out the suctioning by the suction table and the fixing by the jig, the negative electrode mixture coating liquid can be more favorably coated on the electrode foil, and the negative electrode mixture coating film can be more favorably formed.

Here, the method of performing screen printing while suctioning the surface of the electrode foil on the side having the positive electrode mixture coating film to the suction table and fixing the uncoated portion of the other surface, at which the negative electrode mixture coating liquid is not to be coated, by the jig will be explained with reference to FIGS. 2A and 2B. FIGS. 2A and 2B illustrate the electrode foil in a state in which the surface on the side having the positive electrode mixture coating film is suctioned to the suction table, and in which the uncoated portion of the other surface, at which the negative electrode mixture coating liquid is not to be coated, is fixed by the jig, with FIG. 2A showing a top view and FIG. 2B showing a cross-sectional view. It should be noted that, for the sake of convenience, FIGS. 2A and 2B illustrate a state after the negative electrode mixture coating film has been formed on the other surface.

As shown in FIGS. 2A and 2B, the electrode foil 4 is arranged on a suction table 20, with the one surface of the electrode foil 4, that is to say, the surface on the side at which a positive electrode mixture coating film 12 has been formed, being on the suction table 20 side. By performing suctioning through suction holes 22 of the suction table 20, the electrode foil 4 is suctioned and fixed to the suction table 20. Moreover, at the other surface, that is to say, at the surface on the side at which the negative electrode mixture coating liquid 2 is coated, the uncoated portion at which the negative electrode mixture coating liquid 2 is not coated is fixed by a jig 30. In FIGS. 2A and 2B, the uncoated portion is present at a periphery of the region in which the negative electrode mixture coating liquid is coated, and the jig 30 is arranged at the uncoated portion. Examples of the jig 30 include a member that fixes the electrode foil 4 to the suction table 20 by magnetic force, and in that case, a member (for example, steel) that attracts the jig 30 by magnetic force is used in the suction table 20.

In this manner, the negative electrode mixture coating liquid 2 is coated on the other surface of the electrode foil 4 by screen printing, while suctioning the surface of the electrode foil 4 on the side having the positive electrode mixture coating film 12 to the suction table 20 and fixing the uncoated portion of the other surface, at which the negative electrode mixture coating liquid 2 is not to be coated, by the jig 30.

### Drying

The drying method in the negative electrode mixture coating step is not particularly limited, and conventionally known drying methods such as a drying method using a drying furnace can be employed.

### Negative Electrode Mixture Coating Liquid

The negative electrode mixture coating liquid includes, for example, a negative electrode active material, a binder, other components, a solvent and the like. Examples of the negative electrode active material include graphite-based carbon such as natural graphite, artificial graphite, and amorphous coated graphite. Examples of the binder contained in the negative electrode mixture coating liquid include rubbers, such as a styrene-butadiene copolymer (SBR), and vinyl halide resins, such as polyvinylidene fluoride (PVdF). The negative electrode mixture coating liquid may further contain other components such as a thickener. Examples of the thickener include celluloses such as carboxymethylcellulose (CMC). Examples of the solvent contained in the negative electrode mixture coating liquid include water.

### (4) Second Pressing Step

In the second pressing step, the electrode foil having the negative electrode mixture coating film is pressed. The pressing method is not particularly limited, similarly as in the first pressing step, and a conventionally known pressing method can be employed. An example thereof is a method of pressing by passing the electrode foil having the negative electrode mixture coating film, between two opposing press rolls.

By respectively adjusting the pressure in the first pressing step and the pressure in the second pressing step, the densities of the positive electrode mixture layer and the negative electrode mixture layer can respectively be arbitrarily adjusted.

By performing (1) the positive electrode mixture coating step, (2) the first pressing step, (3) the negative electrode mixture coating step, and (4) the second pressing step as described above, a bipolar electrode is obtained.

### Battery

A bipolar electrode produced by the method for producing a bipolar electrode according to an embodiment of the present disclosure is used as an electrode of a bipolar battery. The bipolar battery includes the bipolar electrode, a separator, and an electrolyte. Either of a liquid electrolyte (that is to say, an electrolytic solution) or a solid electrolyte may be used as the electrolyte.

Examples of a use of the bipolar battery include use as a power source for a hybrid electric vehicle (HEV), a plug-in hybrid electric vehicle (PHEV), a battery electric vehicle (BEV) or the like.

### EXPLANATION OF REFERENCE NUMERALS

The reference numerals used in the figures represent the following elements.

2: negative electrode mixture coating liquid

4: electrode foil

6: screen

8: squeegee

12: positive electrode mixture coating film

20: suction table

22: suction holes

30: jig

60: frame

1. A method for producing a bipolar electrode, the method comprising obtaining a bipolar electrode respectively having a positive electrode mixture layer and a negative electrode mixture layer at both surfaces of an electrode foil through:
coating a positive electrode mixture coating liquid on one surface of an electrode foil and drying the positive electrode mixture coating liquid, to form a positive electrode mixture coating film;
pressing the electrode foil having the positive electrode mixture coating film;
coating a negative electrode mixture coating liquid on another surface of the electrode foil by a screen printing method and drying the negative electrode mixture coating liquid, to form a negative electrode mixture coating film; and
pressing the electrode foil having the negative electrode mixture coating film.

2. The method for producing a bipolar electrode according to claim 1, wherein a viscosity of the negative electrode mixture coating liquid at a shear rate of 1 s⁻¹ is from 10,000 mPa·s to 30,000 mPa·s.

3. The method for producing a bipolar electrode according to claim 1, wherein a printing pressure in the screen printing method in the coating of the negative electrode mixture coating liquid is from 0.15 MPa to 0.4 MPa.

4. The method for producing a bipolar electrode according to claim 1, wherein a squeegee speed in the screen printing method in the coating of the negative electrode mixture coating liquid is 200 mm/s or less.

5. The method for producing a bipolar electrode according to claim 1, wherein the coating of the negative electrode mixture coating liquid on the other surface by the screen printing method is performed while suctioning the surface of the electrode foil on a side having the positive electrode mixture coating film to a suction table, and while fixing an uncoated portion of the other surface, at which the negative electrode mixture coating liquid is not to be coated, by a jig.
